(19) United States
(12) Patent Application Publication
(10) Pub. No.: US 2007/0216369 A1
(43) Pub. Date: Sep. 20, 2007

(54) Maximum Energy transfer through cell isolation and discharge

(75) Inventor: Lance Chandler, Toutle, WA (US)

Correspondence Address: WALLACE G. WALTER, 5726 CLARENCE AVE, ALEXANDRIA, VA, 22311-1008, US

(73) Assignee: Intersil

(21) Appl. No.: 10/937,735

(22) Filed: Sep. 8, 2004

Related U.S. Application Data
(60) Provisional application No. 60/501,542, filed on Sep. 8, 2003.

(51) Int. Cl. H02J 7/00

(52) U.S. Cl. 320/136

(57) ABSTRACT

A battery system includes a multi-cell battery pack in electrical communication with a load. The voltages of each cell are individually monitored by the microcontroller, such as with a high-impedance input terminal. Across each of the cells is a transistor-resistor combination such that by providing a voltage to the gate of each of the transistors, a short-circuit is created through the corresponding cell thereby providing an additional current drain on the cell. More specifically, by turning on the transistor, a short-circuit current (I_{SQ1}) is drawn from the cell through resistor (R1) to provide for the isolated discharge of the specific cell. By selectively measuring each of the cells in a multi-cell battery pack to determine if any of the cells are over-voltage, and if so, by increasing the current drain on that specific cell, the overall maximum amount of energy can be transferred to a load across the battery pack. Moreover, this selectively isolation and discharge provides a mechanism for maintaining a constant charge across all batteries in a multi-cell batter pack.

### RELATED APPLICATIONS

This application claims the benefit of priority to U.S. Provisional Patent Application Ser. No. 60/501,542 filed Sep. 8, 2003, currently co-pending.

### FIELD OF THE INVENTION

The present invention relates generally to a method of cell balancing in batteries. More specifically, the present invention pertains to a method of balancing the discharge levels for individual cells in a multi-cell battery pack, including all Lithium chemistry batteries.

### BACKGROUND OF THE INVENTION

FIG. 2 presents a graph of a typical discharge curve for a multi-cell lithium chemistry battery pack, and is generally designated 200. Graph 110 includes three separate discharge voltage plots 202, 204, 206 representing the voltages of three separate cells within a typical battery pack. In a typical application, the cells within a battery pack are initially charged to a starting voltage 210. As the cells are applied to a load, the voltages within these cells decrease over time as represented by voltage discharge curves 202, 204, and 206.

Due the variations within the chemistry of each cell, and the natural variability of the cells' discharge characteristics, all of the cells in a battery pack do not discharge at the same rate. For example, as shown in FIG. 2, discharge curve 206 has a steeper discharge profile than do discharge curves 202 and 204. As a result of this steeper discharge profile, the cell corresponding to curve 206 is discharged to a minimum acceptable voltage level 212 much earlier than the other cells. For instance, curve 202 intersects the minimum acceptable voltage level 212 a period of time after curve 206, as shown by time interval 216.

As a result of this uneven discharging of cells within a battery pack, it is possible that voltage levels on cells within a battery pack may vary significantly. This can result in fault conditions developing with the battery pack, and may also result in the only partial discharge of the cells which discharge more slowly. This partial discharge can result in conditions where the battery pack can no longer be fully charged to achieve maximum cumulative battery pack capacity.

While FIG. 2 depicts a typical discharge profile for a lithium cell battery, it is to be appreciated that due to manufacturing techniques and distinctions in the chemistry within each battery cell, the particular discharge profiles may vary from cell to cell. This variance is also due to the difference in charge/discharge cycles for each battery.

### SUMMARY OF THE INVENTION

The present invention includes a battery system having a battery pack in electrical communication with a load that receives a current from the battery pack. In a preferred embodiment, the battery pack includes a microcontroller and a number of battery cells in a series circuit configuration. The voltages of each cell are individually monitored by the microcontroller, such as with a high-impedance input terminal. More specifically, the voltages of cells are measured by the microcontroller as voltage inputs.

Across each of the cells is a transistor-resistor combination. Specifically, a resistor and transistor are configured to provide an electrical circuit across its adjacent cell. In this configuration, it is to be appreciated that by providing a voltage to the gate of each of the transistors, a short-circuit is created through the corresponding cell thereby providing an additional current drain on the cell. More specifically, by turning on the transistor, a short-circuit current (I_{SQ1}) is drawn from the cell through resistor (R1) to provide for the isolated discharge of the specific cell.

By selectively measuring each of the cells in a multi-cell battery pack to determine if any of the cells are over-voltage, and if so, by increasing the current drain on that specific cell, the overall maximum amount of energy can be transferred to a load across the battery pack. Moreover, this selectively isolation and discharge provides a mechanism for maintaining a constant charge across all batteries in a multi-cell batter pack.

### DESCRIPTION OF THE DRAWING

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a block diagram of the present invention showing the microcontroller in electrical communication with each cell in a multi-cell battery pack, and a transistor-resistor combination wherein the transistor-resistor combination may be activated by the microcontroller to form a short-circuit across one or more of the cells;

FIG. 2 is a graphical representation of a typical discharge curve for a prior art multi-cell battery pack showing the disparity between the discharging of the various cells within the multi-cell battery pack;

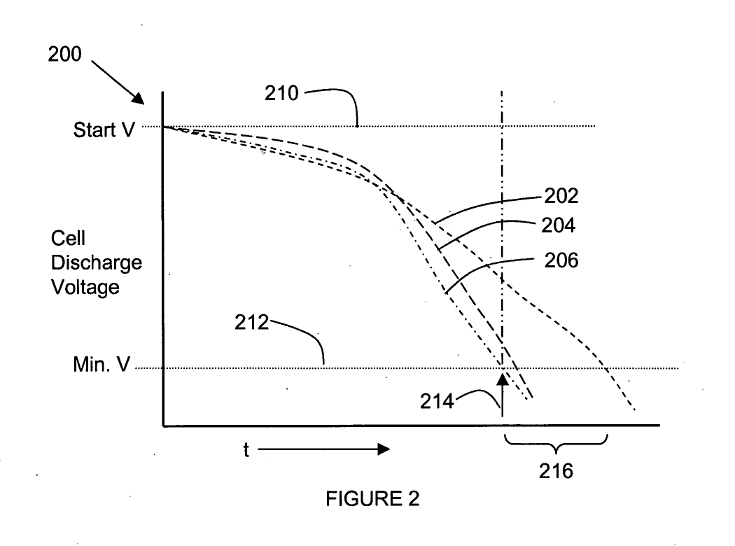

FIG. 3 is a graphical representation of the discharge voltages of the cells within the multi-cell battery pack of the present invention wherein the voltage of one or more cells is selectively and temporarily discharged to maintain a maximum voltage difference between the cells;

FIG. 4 is a graphical representation of the discharge voltages of a cell of the present invention showing the various intervals of selective discharge to maintain the difference between cell voltages within a maximum value; and

FIG. 5 is a flow chart showing the operation of the system of the present invention and depicting the repetitive measurement, voltage comparison, and temporary and selective discharging of one or more cells to maximize the energy transfer from the multi-cell battery pack.

### DESCRIPTION OF A PREFERRED EMBODIMENT

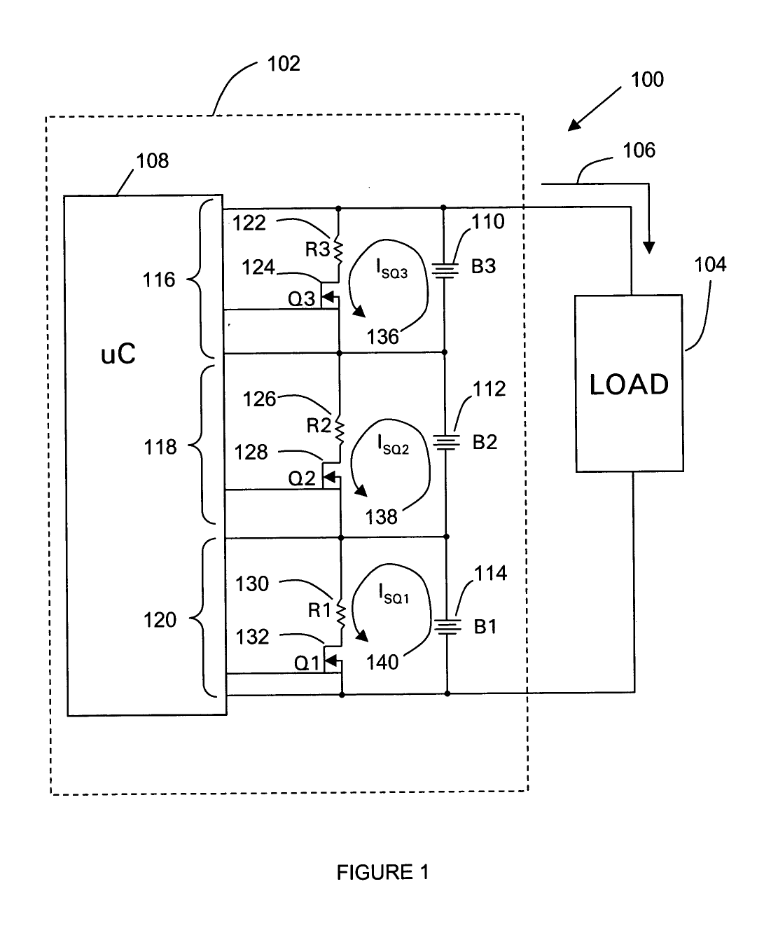

Referring to FIG. 1, a battery system of the present invention is shown and generally designated 100. System 100 includes a battery pack 102 in electrical communication with a load 104 that receives a current 106 from battery pack 102. In a preferred embodiment, the battery pack 102 includes a microcontroller 108 and a number of battery cells 110 (B3), 112 (B2), and 114(B1), in a series circuit configuration. The voltages of each cell 110, 112, and 114 are individually monitored by microcontroller 108, such as with a high-impedance input terminal. More specifically, the voltages of cells 110, 112 and 114 are measured by microcontroller 108 as voltage inputs 116, 118, and 120.

Across each cell 110, 112, and 114 is a transistor-resistor combination. Specifically, resistor 122 and transistor 124 are configured to provide an electrical circuit across cell 110 (B3). Similarly, resistor 126 and transistor 128 provide an electrical circuit across cell 112 (B2), and resistor 130 and transistor 132 provide an electrical circuit across cell 114 (B1). It this configuration, it is to be appreciated that by providing a voltage to the gate of each of the transistors, a short-circuit is created through the corresponding cell thereby providing an additional current drain on the cell. More specifically, by turning on transistor 132 (Q1), a short-circuit current 140 (I_{SQ1}) is drawn from cell 114 (B1) through resistor 130 (R1) to provide for the isolated discharge of cell 114 (B1).

In a preferred embodiment, transistors 124, 128 and 132 are Field Effect Transistors (FET) having a low R_{ds-on}. Resistors 122, 126, and 130 may be used in the circuit of the present invention to limit the current draw from the cell, and to avoid over-current conditions for the transistors. However, it is to be appreciated that these resistors may be omitted without departing from the scope of the present invention. In such a circuit, it is important that the transistor used is capable of passing sufficient current.

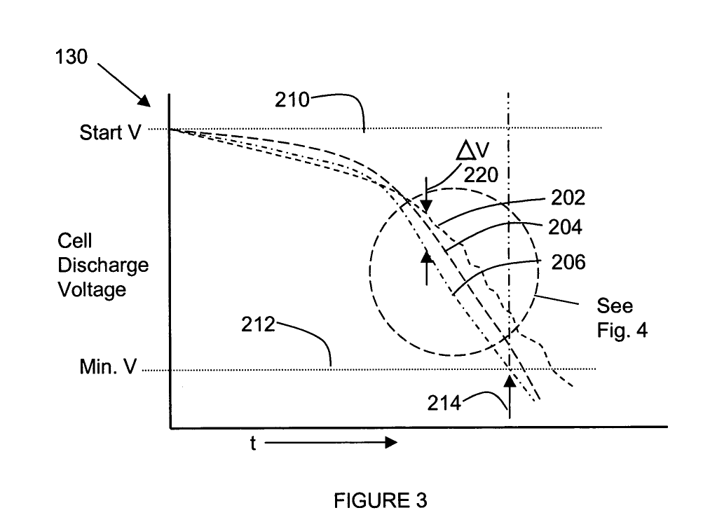

Using the circuit of the present invention, the discharging of each of the individual cells within a battery pack may be adjusted to maintain the cells at approximately the same discharged state. For instance, by using the circuit of the present invention, when one or more cells have a voltage difference that is greater than a pre-determined maximum voltage difference, the over-voltage cell or cells may be selectively discharged. For instance, referring to FIG. 3, the various cell discharge curves of FIG. 1 are shown. However, when the discharge voltages exceed a maximum voltage (Vmax), such as that shown by ΔV at location 220 (between curves 202 and 206), the cell corresponding to the higher voltage (curve 202) is selectively discharged.

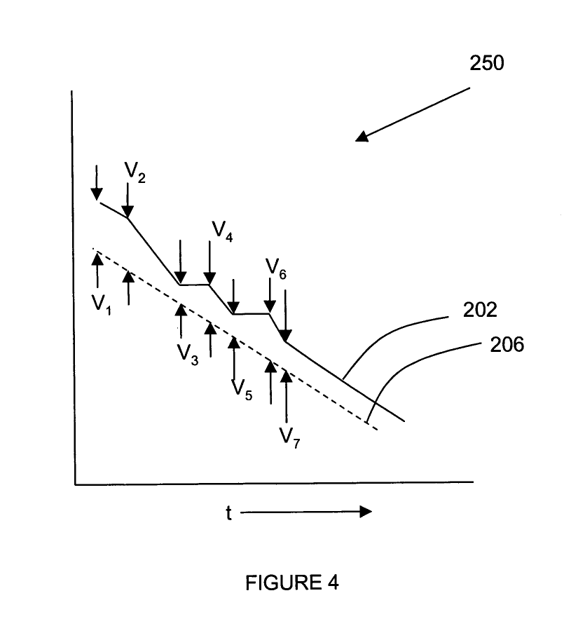

Referring to FIG. 4, a detailed view of the voltage differences between curves 202 and 206 are shown and generally designated 250. When the voltage difference 220 exceeds the predetermined maximum, the over-voltage cell is temporarily discharged by switching on its associated transistor. Once the voltage difference is again within the predetermined maximum, the associated transistor is turned off, thereby allowing the cell to discharge in its normal capacity within the battery pack.

Table 1 below summarizes the operation of the battery system of the present invention in operation.

| Voltage Point | Voltage Difference | FET Position | Mode |
|---|---|---|---|
| V1 | V1 < Vmax | OFF | Open Circuit |
| V2 | V2 > Vmax | ON | Discharge |
| V3 | V3 < Vmax | OFF | Open Circuit |
| V4 | V4 > Vmax | ON | Discharge |
| V5 | V5 < Vmax | OFF | Open Circuit |
| V6 | V6 > Vmax | ON | Discharge |
| V7 | V7 < Vmax | OFF | Open Circuit |

The voltage differences that trigger the cell discharge circuit may vary in order to insert a modicum of hysteresis into the battery system, and to avoid a rapid on-off switching of the transistor when the voltage difference is close to the maximum voltage threshold.

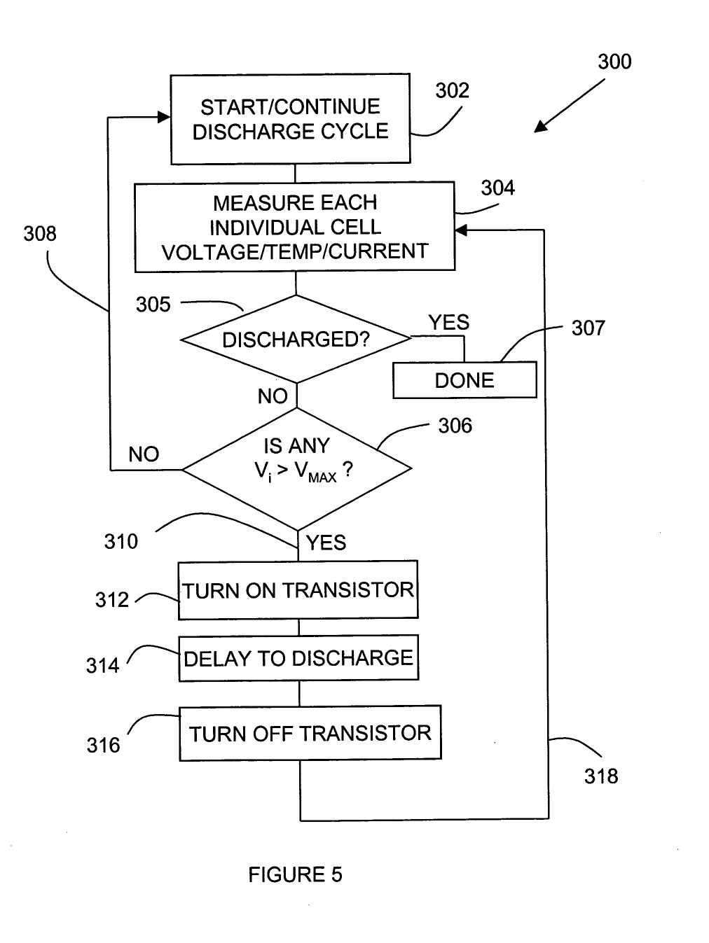

Referring to FIG. 5, a flow chart of a typical operation of the battery system of the present invention, and generally designated 300. Method 300 begins with the discharge cycle start in step 302. Each individual cell voltage is measured in step 304, along with other critical cell parameters, such as temperature and current. If the battery is fully discharged as identified in step 305, the discharge process is finished in step 307, otherwise the system proceeds to step 306.

In step 306, the measured voltages for each cell are compared to the other cells. If one or more of the cells is not more than a predetermined voltage (Vmax) greater than its companion cell voltages, the system 300 returns on path 308 to continue the discharging cycle in step 302. However, if one or more of the cells is more than a predetermined voltage greater than its companion cell voltages, system 300 proceeds along path 310 to step 312 where the transistor associated with the over-voltage cell is turned ON, and the shunt resistor is placed across the over-voltage cell. This step 312 may involve placing a shunt resistor across more than one cell.

Method 300 provides a delay in step 314 during which the over-voltage cells are discharged through its corresponding transistor to provide for the balancing of the cell voltages within a battery pack. Following the delay in step 314, the transistors are turned OFF in step 316, thereby removing the shunt resistors from the discharge circuit. Via return path 318, the discharge circuit is continued in step 302, and the cell voltages are once again measured in step 304. In the event that the battery is not fully discharged, and the differences in cell voltages continue to exceed the threshold voltage (Vmax) as measured in step 306, the transistors corresponding to the over-voltage cells are once again turned ON for a delay period and the process repeats.

The benefit of the battery system of the present invention is that the voltage of the individual cells within a battery pack are maintained within a small voltage differential, resulting in a battery pack having all cells at approximately the same charge condition. Further, using the circuit of the present invention provides for a battery pack in which the voltage levels of the cells are maintained stable and relatively equal during the discharge which is particularly important in linear applications.

Important characteristics of the method of discharge circuit, include the constant voltage monitoring of the cells within a multi-cell battery pack to maintain balance between different cells. The current invention provides for the charge accuracy per cell in that a battery of the present invention fully discharges each cell, not just the battery pack, improving cycle life of the pack. Also, by maintaining a constant and even discharge between the cells within a battery pack under voltage conditions which give rise to metallization of cells can be avoided. The continuous monitoring of each of the cell voltages provides for the analysis of hazardous cell conditions, such as over-voltage, under-voltage, over-temperature, etc. The system of the present invention allows for the selective discharge of each cell within a battery pack to provide for the maximum charging of the pack as each cell will be similarly discharged at the start of the charging cycle.

An algorithm is used for discharging the cells within the battery pack, include parameters for: certain battery characteristics, such as a data set for each type of battery construction, chemistry, etc. In a preferred embodiment, the algorithms is loaded via a PROM into a microprocessor, microcontroller, etc. to provide a control function to a battery pack of the present invention. In a preferred embodiment, an ASIC may be used for for an embedded solution.

While the particular method and apparatus for Maximum Energy Transfer Through Cell Isolation and Discharge as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

I claim:

1. A method for optimizing the transfer of energy from a cell in a multi-cell battery, comprising the steps of:
beginning a discharge cycle;
measuring each cell of said multi-cell batter;
comparing measured values of all cells;
determining if one or more of the cells is more than a predetermined voltage (Vmax) greater than its companion cell voltages;
turning on the transistor associated with an over-voltage cell to place a shunt resistor across the over-voltage cell.
discharging the over-voltage cell through its corresponding transistor for a predetermined time to provide for the balancing of the cell voltages within said multi-cell battery pack;
turning off the transistor associated with the over-voltage cell thereby removing the shunt resistor from the discharge circuit;
continuing the discharge of the multi-cell battery.
